(19) United States
(12) Patent Application Publication
(10) Pub. No.: US 2009/0293786 A1
(43) Pub. Date: Dec. 3, 2009

(54) Biomass Combustion Chamber and Refractory Components

(76) Inventor: John W. Olver, Blacksburg, VA (US)

Correspondence Address: JOHNSTON, HOLROYD & ASSOCIATES, 1438 MAIN STREET, PRINCETON, WV, 24740, US

(21) Appl. No.: 12/127,606

(22) Filed: May 27, 2008

(51) Int. Cl. F23M 5/00; B32B 17/06; B05D 1/02

(52) U.S. Cl. 110/336; 428/426; 427/427

(57) ABSTRACT

A combustion chamber has refractory walls, with an input feeding biomass into the chamber, and an ignition source to ignite the biomass. Each refractory wall component, refractory brick, panel or castable, has a surface exposed to heat generated within the chamber with a thermal protective layer consisting of a thermal enhancing high emissivity coating disposed on the exposed refractory surface. The coating contains from about 5% to about 35% of colloidal silica, colloidal alumina, or combinations thereof, from about 23% to about 79% of a filler, and from about 1% to about 20% of one or more emissivity agents.

### BACKGROUND OF THE INVENTION

The combustion of biomass in the production of energy is increasing in response to increased pressures on other energy sources. The amount of radiation energy absorbed and reradiated from the biomass combustor walls occurs over a complete electromagnetic spectrum for radiative heat; hence, the combustor's thermal and combustion efficiency significantly improves if the emissivity and performance of the walls are changed. This is also true of the medium, such as for example process tubes, through which heat transfer takes place to perform the desired work, such as for example heating water/steam for use in facility heating systems, or in the generation of electricity.

Refractories are classified as basic, high aluminum, silica, fireclay and insulating. Special refractories include silicon carbide graphite, zircon, zirconia, and fused cast, among others. Refractory lining may be formed of bricks, panels, castables, or thermal ceramic fiber to cover the interior of the combustion chamber. The refractory materials, both hard and ceramic fiber, incorporated into the combustion chamber contain the heat within the combustion chamber. The chambers themselves can impact the thermal and combustion efficiency of the load or fuel.

U.S. Pat. No. 6,640,548 issued to Brushwood et al. on Nov. 4, 2003 discloses an apparatus and method for combusting low quality gas or liquid fuel which involves mixing high quality and low quality fuels to produce a steady combustion flame, and uses the heat generated by the flame to perform work, specifically to power a turbine to turn a generator. U.S. Pat. No. 6,474,067 issued to Shishido et al. on Nov. 5, 2002 teaches an apparatus and method for resource recovery from organic substance which generates electricity using a gas turbine, hot water is also generated by heating water in a radiator, and other work in generated thereby. The organic substance includes wood chips, bark and the like and is introduced into a combustion chamber using a screw conveyor input apparatus and hopper.

Small scale biomass plants are known which convert the combustion of biomass into work, such as heating water, or turning a turbine to generate electricity, and the like. U.S. Pat. No. 5,678,494 issued to Ulrich on Oct. 21, 1997 teaches a biomass-fueled furnace which heats water, uses wood chips as the preferred fuel, and uses a gravity style feeder to advance the fuel into the combustion chamber. U.S. Pat. No. 4,559,882 issued to Dobson on Dec. 24, 1985 teaches a biomass-fueled furnace having a combustion chamber, and a gravity fed biomass inlet, which generates heat by warming air. U.S. Pat. Nos. 4,579,102 and 4,449,510 issued to Sukup, on Apr. 1, 1986 and May 22, 1984 respectively, teaches a biomass heat exchanger furnace that screw feeds agricultural waste into a combustion chamber to generate heated air for drying crops.

U.S. Pat. No. 4,483,256 issued to Brashear on Nov. 20, 1984 teaches a biomass gasifier combustor system and components therefore having a combustion chamber, with a castable refractory forming the roof, and a screw feeder system for feeding a biomass fuel to the furnace. A venture deuctor system is adapted to draw a gaseous combustion product from the combustion chamber; the gaseous combustion product is then fed into a fuel storage source. Similarly, U.S. Patent Application No. 2008/0,016,756 issued to Pearson and published on Jan. 24, 2008 discloses a conversion of carbonaceous materials to synthetic natural gas by reforming and methanation has a combustion chamber and feeds biomass therethrough.

The biomass is advanced into the combustion chamber by a variety of traditional apparatuses including screw mechanisms, converyor systems, and gravity, and the like. U.S. Pat. No. 6,973,789 issued to Sugarmen et al. on Dec. 13, 2005 teaches a method of and apparatus for producing power in remote locations which includes a biomass combustion chamber. The biomass is introduced into the chamber via a screw mechanism, and the heat operates on a working fluid including a turbine to produce electricity, and a condenser and evaporator to recycle the working fluid. U.S. Pat. No. 4,454,828 issued to Zempel on Jun. 19, 1984 discloses a system for burning biomass pellets in a combustion chamber where a screw mechanism is used to advance the biomass pellets into the combustion chamber.

Efforts to coat refractory bricks and surfaces with a layer of protective refractory material or the like to modify the properties of the refractory brick or to increase their endurance are also known. For example, U.S. Pat. No. 4,664,969 issued to Rossi et al. on May 12, 1987 teaches a method for spray applying a refractory layer on a surface and the layer produced thereby. The refractory layer consisted of a refractory fiber spray applied to a surface, including the inside surfaces of a combustion chamber. An alumina containing binder, preferably aluminum chloride, is used in a spray method to bond the fiber to itself and to a substrate surface. A refractory layer comprised of fiber and binder produced by the method of the invention. The refractory layer may be coated on refractory bricks and the like. The refractory layer of Rossi et al. is quite thick and performs a function similar to castable refractory material.

### SUMMARY OF THE INVENTION

The present invention is an advance in utilizing material science technology to improve the thermal and combustion efficiency of a biomass combustor and the resultant work performed by heat transfer, for example, to process tubes. Radiative heat transfer is different from heat transfer by conduction or convection. Electromagnetic waves transmit the energy rather than a medium in radiative heat transfer. The properties of any material's surface tend to dominate eighty to ninety percent of that material performance in heat and combustion systems. The need to control air emissions and global warming while increasing the efficiency in biomass combustions is desirable. Improved fuel utilization and increased thermal output are desirable.

The combustion chamber, according to various embodiments of the present invention, has refractory walls, with an input or inlet continually feeding biomass into the chamber, and an ignition source to ignite the biomass, and an outlet for work to be performed on which may include, for example, boiler tubes. Each refractory wall component, refractory brick, panel or castable, has a surface exposed to heat generated within the chamber with a thermal protective layer consisting of a high emissivity coating disposed on the exposed refractory surface and alters the performance of the refractory surface. The thermal protective layer contains from about 5% to about 35% of colloidal silica, colloidal alumina, or combinations thereof, from about 23% to about 79% of a filler, and from about 1% to about 20% of one or more emissivity agents.

An aspect of the present invention is improved combustion, fuel usage, fuel transformation, and heat transfer to produce work while also reducing NOₓ, CO, CO₂, and particulate air emissions.

Another aspect of the present invention is reduction in biomass combustion facility maintenance, increased refractory life and reduced fly-ash disposal. The present invention results in increased life of refractory and metal components coupled with reduced maintenance. Fly-ash generation is reduced which decreases disposal costs and environmental impacts.

Yet another aspect of the present invention is reduced slag and soot formation on the combustion chamber walls on the combustion chamber walls.

Increased operational responsiveness of the entire combustion system results from application of a thermal protective layer on the refractory surfaces.

In an existing biomass combustion plant, the present invention by changing the surface properties of key components results in improvements that require changes in excess air, fuel put through air to fuel ratio, air to input ratio, temperature set points, and monitoring parameters to fully realize all aspects of the present invention.

These and other aspects of the present invention will become readily apparent upon further review of the following drawings and specification.

### BRIEF DESCRIPTION OF THE DRAWINGS

The novel features of the described embodiments are specifically set forth in the appended claims; however, embodiments relating to the structure and process of making the present invention, may best be understood with reference to the following description and accompanying drawings.

FIG. 1 shows a schematic top view of a generic biomass combustion chamber having refractory wall components disposed along the walls with a layer of thermal protective coating disposed on the exposed surfaces of the wall components according to an embodiment of the present invention.

FIG. 2 shows a cross sectional view of a chamber wall having a castable refractory disposed thereon with a layer of thermal protective coating on the exposed castable refractory surface according to an embodiment of the present invention.

FIG. 3 shows a cross sectional view of a chamber wall having refractory bricks disposed thereon with a layer of thermal protective coating on the exposed refractory bricks surface according to an embodiment of the present invention.

FIG. 4 shows a cross sectional view of a chamber wall having refractory panels disposed thereon with a layer of thermal protective coating on the exposed refractory panels' surface according to an embodiment of the present invention.

FIG. 5 shows a cross sectional view of different refractory components used adjacent one another with a single thermal protective layer disposed thereon according to an embodiment of the present invention.

FIG. 6 shows a graph comparing the emissivity versus temperature characteristics of coated and uncoated refractory component surfaces for a biomass combustor.

FIG. 7 is a table depicting realized aspects of an embodiment of the present invention which is indicated by FIG. 6.

Similar reference characters denote corresponding features consistently throughout the attached drawings.

### DETAILED DESCRIPTION OF PREFERRED EMBODIMENTS

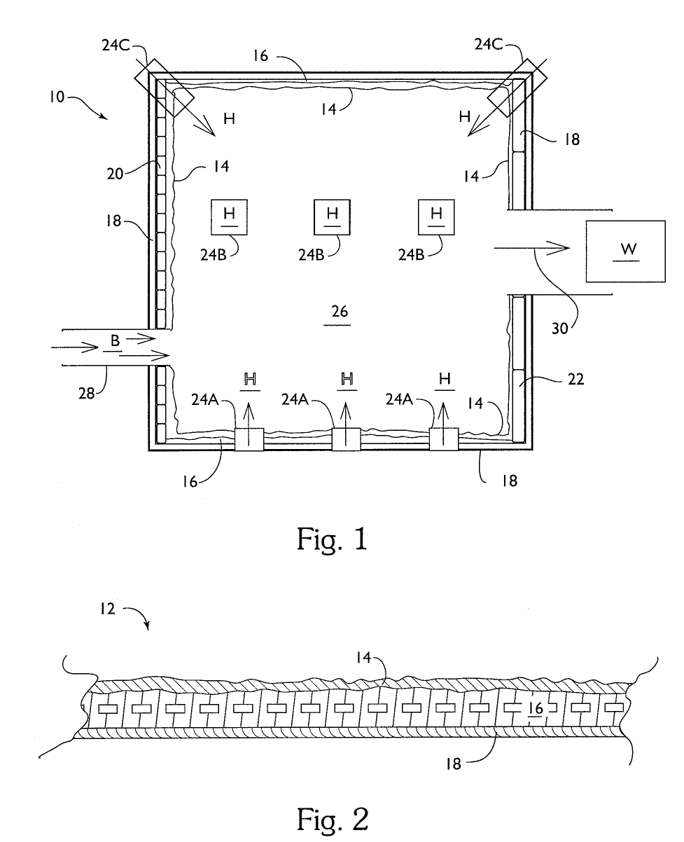

A thermal protective layer 14 may be disposed on at least a part or all of the exposed refractory surfaces of a biomass combustion chamber 10. A generic biomass combustion chamber 10 is depicted in FIG. 1. In some combustion chambers 10, at least part of the combustion chamber 10 wall 18 is composed of a plurality of refractory bricks 20, refractory board 22, or refractory castable 16, and combinations thereof, disposed therein forming an exposed surface of the chamber 10. In other combustion chambers, castable or ceramic fiber is used to form the refractory surface of the chamber 10, as is well known in the art. Ignition burners 24A-C may be provided alternatively, and in combination, in the floor 26 at 24B, in the sides of the chamber 10 at 24A, or in the corners at 24C to ignite the biomass and to provide a supply of gas, such as air, to facilitate the combustion of the biomass.

The biomass B is fed into the chamber 10 using a conventional inlet 28. Although multiple inlets may be utilized, as appropriate, the present invention is described by way of a single inlet 28. The term “inlet”, however, is seen to include both single access inlets and multiple inlets disposed separately or together. Inlets 28 are well known in the art and include conveyors, screws, gravity operated systems, and the like, and combinations thereof, as is well known in the art. The heat generated by the combustion of the biomass is available to perform work W at 30. Work includes heating boiler tubes containing water, oil, air, and the like, to generate heat, hot water, steam, or electricity, and the like, and combinations thereof, as is well known in the art. The work W performed may alternatively be converted to electricity by rotating a turbine connected to a generator.

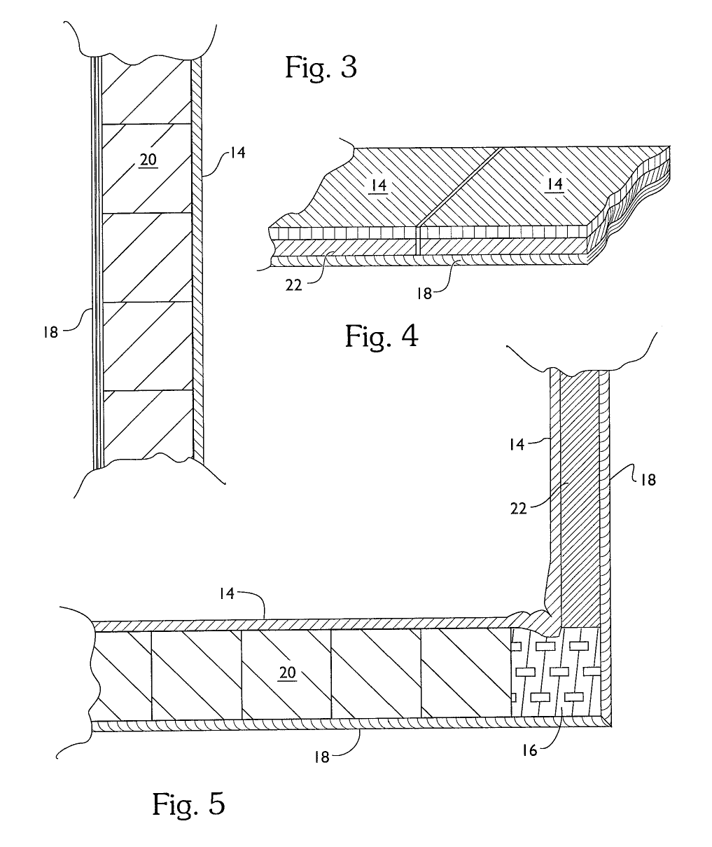

FIG. 2 shows a cross sectional view of a chamber wall 18 having a castable refractory 16 disposed thereon with a thermal protective layer 14 of thermal protective coating on the castable refractory 16 surface opposite the chamber wall 18. FIG. 3 shows a cross sectional view of a chamber wall 18 having refractory bricks 20 disposed thereon with a thermal protective layer 14 disposed on the surface of the refractory bricks 20 opposite the chamber wall 18. FIG. 4 shows a cross sectional view of a chamber wall 18 having refractory panels 22 disposed thereon with a layer 14 of thermal protective coating on the refractory panels' 22 surface opposite the chamber wall 18. FIG. 5 shows a cross sectional view of different refractory components 16, 20 and 22 used adjacent one another with a single thermal protective layer 14 disposed thereon opposite the chamber wall 18, as shown. Although some biomass combustion chambers 10 have only one kind of refractory component 16, 20 and 22, others have combination of refractory components. Refractory castables 16 are especially useful for corners or where gaps occur.

Various biomass combustion chambers for energy production and heat generation are described in Wood for Energy Production, National Council for Forest Research & Development, Danish Energy Authority, Irish Edition, 2005, the contents of which are incorporated herein in their entirety. The present invention is suited to being used in the biomass combustion chamber of a variety of applications to do work including heating boiler tubes, generating fluid flow to turn a carbine, and the like, to generate electricity, facility heat, and the like, and combinations thereof.

Examples of refractory walls include Empire (trademark) S, which is a high duty dry press fireclay brick, Clipper™, Korundal XD™ and Insblok-19 available from A.P. Green Industries, Inc. (of Mexico, Mo.). An example of a ceramic fiber refractory includes Insboard 2300 LD also available form A.P. Green Industries, Inc. which is a refractory board. These refractory materials contains approximately 9.7% to 61.5% silica (SiO₂), 12.1% to 90.0% alumina (Al₂O₃), 0.2% to 1.7% iron oxide (Fe₂O₃), up to 27.7% lime (CaO), 0.1% to 0.4% magnesia (MgO), 2.0% to 6.3% titania (TiO₂) and 0.1% to 2.4% of alkalies (Na₂O plus K₂O). Refractory castables are available, as an example, from Armil, C.F.S. (of South Holland, Ill.).

The thermal protective layer 14 may be applied as a multifunctional thermal enhancing high emissivity protective coating. Suitable coatings and methods of application for ceramic surfaces such as refractories are described in U.S. Pat. No. 6,921,431 and assigned to Wessex Incorporated, the contents of which are incorporated herein in their entirety. Similar coatings and methods of application for metal substrates are further described in U.S. Pat. No. 7,105,047, also assigned to Wessex Incorporated, the contents of which are incorporated herein in their entirety.

An alternative multifunction thermal enhancing high emissivity coating suitable for forming a thermal protective layer on a ceramic process tubes and assembly, and on ceramic refractory wall materials, including brick, panel, castable and ceramic fiber refractory walls, according to an embodiment of the present invention may contain from about 5% to about 35% of colloidal silica, from about 23% to about 79% of a filler, from about 1% to about 20% of one or more emissivity agents. Preferably, a thermal protective layer of the present invention also contains from about 1.5% to about 5.0% of a stabilizer.

As used herein, all percentages (%) are percent weight-to-weight, also expressed as weight/weight %, % (w/w), w/w, w/w % or simply %, unless otherwise indicated. Also, as used herein, the terms “wet admixture” refers to relative percentages of the composition of the thermal protective coating in solution and “dry admixture” refers to the relative percentages of the composition of the dry thermal protective coating mixture prior to the addition of water. In other words, the dry admixture percentages are those present without taking water into account. Wet admixture refers to the admixture in solution (with water). “Wet weight percentage” is the weight in a wet admixture, and “dry weight percentage” is the weight in a dry admixture without regard to the wet weight percentages. The term “total solids”, as used herein, refers to the total sum of the silica/alumina and the alkali or ammonia (NH₃), plus the fraction of all solids including impurities. Weight of the solid component divided by the total mass of the entire solution, times one hundred, yields the percentage of “total solids”.

Method of preparation of coating involves applying a wet admixture of the coating to the surface to be coated. Alternative methods may include spraying the wet admixture on the surface or atomizing the dry admixture and coating the surface accordingly.

In a coating solution according to the present invention, a wet admixture of an alternative thermal protective coating, to be applied to the refractory structure and ceramic process tubes/assembly, contains from about 15% to about 45% of colloidal silica, from about 23% to about 55% of a filler, from about 0.5% to about 10% of one or more emissivity agents, from about 0.5% to about 2.5% of a stabilizer and from about 18% to about 40% water. The wet admixture coating solution contains between about 40% and about 70% total solids.

The colloidal silica is preferably a mono-dispersed distribution of colloidal silica, and therefore, has a very narrow range of particle sizes. The filler is preferably a metal oxide taken from the group consisting of silicon dioxide, aluminum oxide, titanium dioxide, magnesium oxide, calcium oxide and boron oxide. The emissivity agent(s) is preferably taken from the group consisting of silicon hexaboride, carbon tetraboride, silicon tetraboride, silicon carbide, molybdenum disilicide, tungsten disilicide, zirconium diboride, cupric chromite, and metallic oxides such as iron oxides, magnesium oxides, manganese oxides, copper chromium oxides, and chromium oxides, cerium oxides, and terbium oxides, and derivatives thereof. The copper chromium oxide, as used in the present invention, is a mixture of cupric chromite and cupric oxide. The stabilizer may be taken from the group consisting of bentonite, kaolin, magnesium alumina silica clay, tabular alumina and stabilized zirconium oxide. The stabilizer is preferably bentonite. Other ball clay stabilizers may be substituted herein as a stabilizer. Colloidal alumina, in addition to or instead of colloidal silica, may also be included in the admixture of the present invention. When colloidal alumina and colloidal silica are mixed together one or the other requires surface modification to facilitate mixing, as is known in the art.

Coloring may be added to the protective coating layer of the present invention to depart coloring to the tubes. Inorganic pigments may be added to the protective coating without generating toxic fumes. In general, inorganic pigments are divided into the subclasses: colored (salts and oxides), blacks, white and metallic. Suitable inorganic pigments include but are not limited to yellow cadmium, orange cadmium, red cadmium, deep orange cadmium, orange cadmium lithopone and red cadmium lithopone.

A preferred embodiment of the present invention contains a dry admixture of from about 10.0% to about 30.0% colloidal silica, from about 50% to about 79% silicon dioxide powder, and from about 2% to about 20% of one or more emittance agent(s) taken from the group consisting of cerium oxide, boron silicide, boron carbide, silicon tetraboride, silicon carbide molybdenum disilicide, tungsten disilicide, zirconium diboride, and from about 1.5% to about 5.0% bentonite powder. The corresponding coating in solution (wet admixture) for this embodiment contains from about 20.0% to about 35.0% colloidal silica, from about 25.0% to about 55.0% silicon dioxide, from about 18.0% to about 35.0% water, and from about 2.0% to about 7.5% one or more emittance agent(s), and from about 0.50% to about 2.50% bentonite powder. Preferably deionized water is used. Preferred embodiments of the wet admixture have a total solids content ranging from about 50% to about 65%.

A most preferred thermal protective coating of the present invention contains a dry admixture from about 15.0% to about 25.0% colloidal silica, from about 68.0% to about 78.0% silicon dioxide powder, about 2.00% to about 4.00% bentonite powder, and from about 4.00% to about 6.00% of an emittance agent. The emittance agent is taken from one or more of the following: zirconium boride, boron silicide, and boron carbide.

A most preferred wet admixture contains about 27.0% colloidal silica based on a colloidal silica solids content of about 40%, from about 25% to about 50% silicon dioxide powder, about 1.50% bentonite powder, and from about 2.50% to about 5.50% of an emittance agent, with the balance being water. The emittance agent is most preferably taken from the group consisting of zirconium boride, boron silicide, and boron carbide. Preferred embodiments include those where the emittance agent comprises about 2.50% zirconium diboride, about 2.50% boron silicide, or from about 2.50% to about 7.50% boron carbide. The specific gravity of a most preferred wet admixture is about 1.40 to 1.50 and the total solids content is about 50% to 60%.

Ludox™ 50 colloidal silica and Ludox™ AS 40 colloidal silica are available from Grace Davidson (of Columbia, Md.). The particles in Ludox™ colloidal silica are discrete uniform spheres of silica which have no internal surface area or detectable crystallinity. Most are dispersed in an alkaline medium which reacts with the silica surface to produce a negative charge. Because of the negative charge, the particles repel one another resulting in stable products. Although most grades are stable between pH 8.5-11.0, some grades are stable in the neutral pH range. Ludox™ colloidal silicas are aqueous colloidal dispersions of very small silica particles. They are opalescent to milky white liquids. Because of their colloidal nature, particles of Ludox™ colloidal silica have a large specific surface area which accounts for the novel properties and wide variety of uses. Ludox™ colloidal silica is available in two primary families: mono-dispersed, very narrow particle size distribution of Ludox™ colloidal silica and poly-dispersed, broad particle size distribution of Ludox™ P. The Ludox™ colloidal silica is converted to a dry solid, usually by gelation. The colloidal silica can be gelled by (1) removing water, (2) changing pH, or (3) adding a salt or water-miscible organic solvent. During drying, the hydroxyl groups on the surface of the particles condense by splitting out water to form siloxane bonds (Si—O—Si) resulting in coalescence and interbonding. Dried particles of Ludox™ colloidal silica are chemically inert and heat resistant. The particles develop strong adhesive and cohesive bonds and are effective binders for all types of granular and fibrous materials, especially when use at elevated temperature is required.

Colloidal alumina is available as Nyacol™ colloidal alumina, and specifically, Nyacol™ AL20, available from Nyacol™ Nano Technologies, Inc. (Ashland, Mass.), and is available in deionized water to reduce the sodium and chlorine levels to less than 10 ppm. It contains about 20 percent by weight of AL₂O₃, a particle size of 50 nm, positive particle charge, pH 4.0, specific gravity of 1.19, and a viscosity of 10 cPs.

The filler may be a silicon dioxide powder such as Min-U-Sil (trademark) 5 silicon dioxide available from U.S. Silica (of Berkeley Springs, W. Va.). This silicon dioxide is fine ground silica. Chemical analysis of the Min-U-Sil (trademark) silicon dioxide indicates contents of 98.5% silicon dioxide, 0.060% iron oxide, 1.1% aluminum oxide, 0.02% titanium dioxide, 0.04% calcium oxide, 0.03% magnesium oxide, 0.03% sodium dioxide, 0.03% potassium oxide and a 0.4% loss on ignition. The typical physical properties are a compacted bulk density of 41 lbs/ft.sup.3, an uncompacted bulk density of 36 lbs/ft³, a hardness of 7 Mohs, hegman of 7.5, median diameter of 1.7 microns, an oil absorption (D-1483) of 44, a pH of 6.2, 97%-5 microns, 0.005%+325 Mesh, a reflectance of 92%, a 4.2 yellowness index and a specific gravity of 2.65.

Emittance agents are available from several sources. Emissivity is the relative power of a surface to absorb and emit radiation, and the ratio of the radiant energy emitted by a surface to the radiant energy emitted by a blackbody at the same temperature. Emittance is the energy reradiated by the surface of a body per unit area.

The boron carbide, also known as carbon tetraboride, which may be used as an emissivity agent in the present invention, is sold as 1000 W boron carbide and is available from Electro Abrasives (of Buffalo, N.Y.). Boron Carbide is one of the hardest man made materials available. Above 1300° C., it is even harder than diamond and cubic boron nitride. It has a four point flexural strength of 50,000 to 70,000 psi and a compressive strength of 414,000 psi, depending on density. Boron Carbide also has a low thermal conductivity (29 to 67 W/mK) and has electrical resistivity ranging from 0.1 to 10 ohm-cm. Typical chemical analysis indicates 77.5% boron, 21.5% carbon, iron 0.2% and total Boron plus Carbon is 98%. The hardness is 2800 Knoop and 9.6 Mohs, the melting point is 4262° F. (2350° C.), the oxidation temperature is 932° F. (500° C.), and the specific gravity is 2.52 g/cc.

1000 W green silicon carbide (SiC), an optional emissivity agent, is also available from Electro Abrasives. Green Silicon Carbide is an extremely hard (Knoop 2600 or Mohs 9.4) man made mineral that possesses high thermal conductivity (100 W/m-K). It also has high strength at elevated temperatures (at 1100° C., Green SiC is 7.5 times stronger than Al₂O₃). Green SiC has a Modulus of Elasticity of 410 GPa, with no decrease in strength up to 1600° C., and it does not melt at normal pressures but instead dissociates at 2815.5° C. Green silicon carbide is a batch composition made from silica sand and coke, and is extremely pure. The physical properties are as follows for green silicon carbide: the hardness is 2600 Knoop and 9.4 Mohs, the melting point is 4712° F. (2600° C.), and the specific gravity is 3.2 g/cc. The typical chemical analysis is 99.5% SiC, 0.2% SiO₂, 0.03% total Si, 0.04% total Fe, and 0.1% total C. Commercial silicon carbide and molybdenum disilicide may need to be cleaned, as is well known in the art, to eliminate flammable gas generated during production.

Boron silicide (B₆Si) (Item# B-1089) is available from Cerac (of Milwaukee, Wis.). The boron silicide, also known as silicon hexaboride, available from Cerac has a—200 mesh (about 2 microns average) and a typical purity of about 98%. Zirconium boride (ZrB₂) (Item# Z-1031) is also available from Cerac with a typical average of 10 microns or less (−325 mesh), and a typical purity of about 99.5%.

Iron oxide (SYN-OX HB-1033T) available from Hoover Color (of Hiwassee, Va.) is a synthetic black iron oxide (Fe₂O₃) which has an iron oxide content of 60%, a specific gravity of 4.8 gm/cc, a tap density (also known as, bulk density) of 1.3 gm/cc, oil absorption of 15 lbs/100 lbs, a 325 mesh residue of 0.005, and a pH ranging from 7 to 10.

Preferably the admixture of the present invention includes bentonite powder, tabular alumina, or magnesium alumina silica clay. The bentonite powder permits the present invention to be prepared and used at a later date. Preparations of the present invention without bentonite powder must be used immediately. The examples provided for the present invention include PolarGel bentonite powder are available from Mineral and Pigment Solutions, Inc. (of South Plainfield, N.J.). Technical grade bentonite is generally used for the purpose of suspending, emulsifying and binding agents, and as Theological modifiers. The typical chemical analysis 59.00% to 61.00% of silicon dioxide (SiO₂), 20.00% to 22.00% of aluminum oxide (Al₂O₃), 2.00% to 3.00% calcium oxide (CaO), 3.50% to 4.30% magnesium oxide (MgO), 0.60% to 0.70% ferric oxide (Fe₂O₃), 3.50% to 4.00% sodium oxide (Na₂O), 0.02% to 0.03% potassium oxide (K₂O), and 0.10% to 0.20% titanium dioxide and a maximum of 8.0% moisture. The pH value ranges from 9.5 to 10.5. Typical physical properties are 83.0 to 87.0 dry brightness, 2.50 to 2.60 specific gravity, 20.82 pounds/solid gallon, 0.0480 gallons for one pound bulk, 24 ml minimum swelling power, maximum 2 ml gel formation, and 100.00% thru 200 mesh. Tabular alumina (Alumina Tab T64 Item 635) and magnesium alumina silica clay (Mag Alum Sil Technical Item 105) are also available from Mineral and Pigment Solutions, Inc.

The admixture of the present invention preferably includes bentonite powder, tabular alumina, or other magnesium alumina silica clay as the stabilizer. The bentonite powder permits the present invention to be prepared and used at a later date. The examples provided for the present invention include PolarGel bentonite powder (Item# 354) available from Mineral and Pigment Solutions, Inc. (of South Plainfield, N.J.). Bentonite is generally used for the purpose of suspending, emulsifying and binding agents, and as rheological modifiers. The typical chemical analysis is 59.00% to 61.00% of silicon dioxide (SiO₂), 20.00% to 22.00% of aluminum oxide (Al₂O₃), 2.00% to 3.00% calcium oxide (CaO), 3.50% to 4.30% magnesium oxide (MgO), 0.60% to 0.70% ferric oxide (Fe₂O₃), 3.50% to 4.00% sodium oxide (Na₂O), 0.02% to 0.03% potassium oxide (K₂O), and 0.10% to 0.20% titanium dioxide and a maximum of 8.0% moisture. The pH value ranges from 9.5 to 10.5. Typical physical properties are 83.0 to 87.0 dry brightness, 2.50 to 2.60 specific gravity, 20.82 pounds/solid gallon, 0.0480 gallons for one pound bulk, 24 ml minimum swelling power, maximum 2 ml gel formation, and 100.00% thru 200 mesh. Tabular alumina (Alumina Tab T64 Item 635) and magnesium alumina silica clay (Mag Alum Sil Technical Item 105) are also available from Mineral and Pigment Solutions, Inc.

Colorants, which may be added to the present invention, include but are not limited to inorganic pigments. Suitable inorganic pigments, such as yellow iron oxide, chromium oxide green, red iron oxide, black iron oxide, titanium dioxide, are available from Hoover Color Corporation. Additional suitable inorganic pigments, such as copper chromite black spinel, chromium green-black hematite, nickel antimony titanium yellow rutile, manganese antimony titanium buff rutile, and cobalt chromite blue-green spinel, are available from The Shepherd Color Company (of Cincinnati, Ohio).

A surfactant may be added to the wet admixture prior to applying the thermal protective layer to the support layer. The surfactant was Surfyonol™ 465 surfactant available from Air Products and Chemicals, Inc. (of Allentown, Pa.). The Surfyonol™ has a chemical structure of ethoxylated 2,4,7,9-tetramethyl 5 decyn-4,7-diol. Other surfactants may be used, such as STANDAPOL™ T, INCI which has a chemical structure of triethanolamine lauryl sulfate, liquid mild primary surfactant available from Cognis-Care Chemicals (of Cincinnati, Ohio). The amount of surfactant present by weight in the wet admixture in from about 0.05% to about 0.2%.

The coating is typically applied wet, and either allowed to air dry or heat dry. The surface should be clear of all dirt, loose material, surfactants, oils, gasses, etc. the surface should be thoroughly cleaned to remove all loose particles with clean oil and water free air blasts. When using the wet admixture containing a stabilizer, solids may settle during shipment or storage. Prior to use all previously mixed coating must be thoroughly re-mixed to ensure all settled solids and clumps are completely re-dispersed. When not using a stabilizer, the coating may not be stored for any period of time. In any case, the coating should be used immediately after mixing to minimize settling.

Mixing instructions for one and five gallon containers. High speed/high shear saw tooth dispersion blade 5″ diameter for one gallon containers and 7″ diameter for five gallon containers may be attached to a hand drill of sufficient power with a minimum no load speed of 2000 rpm shear. Dispersion blades can be purchased from numerous suppliers. Mix at high speed to ensure complete re-dispersion for a minimum of 30 minutes.

The product should be applied in a properly ventilated and well lit area, or protective equipment should be used appropriate to the environment, for example within a combustion chamber. The mixed product should not be filtered or diluted.

A high volume low pressure (HVLP) spray gun should be used with 20-40 psi of clean, oil and water free air. Proper filters for removal of oil and water are required. Alternatively, an airless spray gun may be used. Other types of spray equipment may be suitable. An airless spray system is preferable for applications on ceramic surfaces such as the refractory materials. Suitable airless spray systems are available from Graco (of Minneapolis, Minn.). Suitable HVLP spray systems, which may be suitable, are available from G.H. Reed Inc. (of Hanover, Pa.). A high speed agitator system integrated into the spray gun system may be desirable. Suitable spray gun tips may be selected to provide the proper thickness, depending upon the thermal protective layer desired, without undue experimentation.

Controlling the coverage density may be critical to coating performance. Dry coating thickness should be from about two (2) mils (about 50 microns (μ)) to about ten (10) mils (about 260μ), depending upon typed, size and condition of substrate. One (1) mil equals 25.4 μl. Proper thickness may vary. Rotation of 90 and 180 degrees is desirable to maintain even coverage. Allow 1 to 4 hours of dry time before the part is handled, depending upon humidity and temperature.

It is desirable to inspect and reapply the thermal protective layer every two to five years, with three to five years being a desirable replacement schedule for maintenance of the thermal protective layer.

An example of the present invention includes a biomass combustor used to generate district heating. The facility was constructed to burn biomass. The combustion chamber of this example had castable refractory surfaces which were covered by a thermal protective layer according to the present invention. The work was performed on metal process tubes, which were also coated with a thermal protective layer, not the subject of the present application. U.S. patent application Ser. No. 12/099,100 discloses a variety of process tubes, including metal ones, with thermal protective layers disposed on surfaces thereof, the contents of which are incorporated herein in their entirety. The heating plant includes a combustion system with a walking grate, and a boiler system, to transfer work, disposed beyond the combustion system and heated by the combustion of biomass, in this example wood chips and/or bark. The biomass is advanced into the combustion chamber using the walking gate. Process tubes in the boiler system included hot water/gas flow through inside of approximately 400 tubes having a 64 to 52 mm inside diameter. The heating plant also included a condenser, and a baghouse for continuous air emission monitoring for NO_{X} and CO.

Performance improvements resulted from the application of coatings according to the present invention. Specifically, production efficiency was increased by ten percent. Fuel changes in response to production efficiency included a reduction of ten percent less fuel with a ten to fifteen percent reduction in fuel cost. Air emissions were also improved with a twenty to twenty-five percent reduction of NO_{X} emissions, forty to fifty percent reduction of CO, and calculated reduction of ten percent CO₂. Particulate emission was also reduced over twenty percent as measured via fly-ash generation rates.

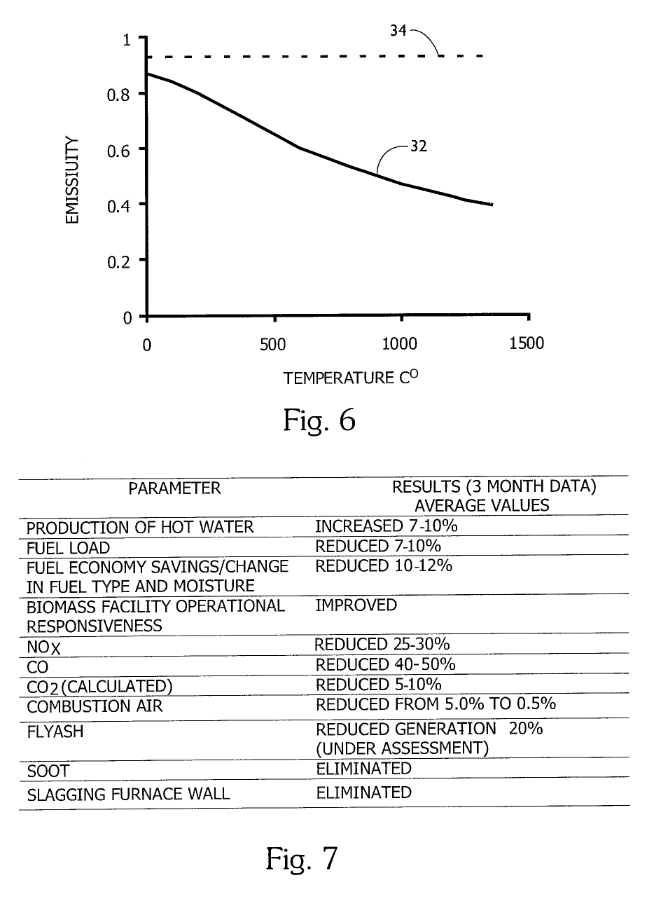

FIG. 5 is a graph showing the results of the application of a thermal protective layer to the surface of a hard refractory resulting in a uniform emissivity and performance improvements over a wide temperature range. Specifically, the graph demonstrates the refractory emissivity versus the temperature to which the refractory is exposed. The thermal protective layered refractory results 34 are consistent versus the uncoated refractory results 32 which has reduced emissivity as temperature of operation increases. As a result, any combustion system is much improved and total performance is enhanced as reflected by the uniform emissivity over a broad temperature range, which positively impacts air emissions, soot and slag formation, fly-ash generation, fuel requirements and the like, as shown in FIG. 6. The results of a four month run are shown in FIG. 6 which is a table showing improved performance found over three months.

In another experimental example, a thermal protective layer was added to aged insulating fire brick on the radiant side wall of a combustion chamber. Specifically, a thermal protective layer containing in wet weight 26.81 percent of Lubox™ 50 colloida silica, 49.6 percent Min-U-Sil 5 SiO₂ powder, 1.88 percent 354 PolarGel, 2.8 percent B1089 SiB₆ Powder and 18.91 percent deionized water was applied to aged castable and fire brick biomass combustion chamber walls using a HVLP or airless spray gun. The boiler tubes which perform the work also had a thermal protective layer applied thereto. The operating temperature was in the range of from 850° C. to 1100° C. The biomass boiler performed with exceptional results immediately after the application of the coating. The confirmed improvements include greater than ten percent increase in output of heated water, reduced NO_{X} air emissions by greater than twenty percent, reduced CO air emissions by greater than fifty percent, significant reduction in fly-ash generation, reduced maintenance, reduced down time, reduced soot formation, reduced refractory slagging, and reduction of disposal costs to discard fly-ash. Also, the fuel utilized was switched to lower quality resulting in reduced operating costs. The fuel type used was wood bark with sixty-one percent moisture, and wood chips with forty-five to fifty percent moisture. The plant increased energy output by ten percent.

It is to be understood that the present invention is not limited to the embodiments described above, but encompasses any and all embodiments within the scope of the following claims.

What is claimed is:

1. A biomass combustion chamber, comprising:
combustion chamber walls with at least a refractory wall component disposed thereon, an input apparatus for continually feeding a biomass into the combustion chamber, and an ignition source to ignite the biomass in the combustion chamber,
each refractory wall component having a surface exposed to heat generated within the combustion chamber by the combustion of biomass; and
at least one thermal protective layer consisting of a thermal enhancing high emissivity coating disposed on at least a part of the exposed refractory surface on the combustion chamber wall, wherein a thermal protective layer contains
from about 5% to about 35% of colloidal silica, colloidal alumina, or combinations thereof; from about 23% to about 79% of a filler, from about 1% to about 20% of one or more emissivity agents.

2. The biomass combustion chamber of claim 1, wherein:
a thermal protective layer further comprises from about 1.0% to about 5.0% of a stabilizer;
a thermal protective layer further comprises up to about 0.25% of a surfactant;
the thermal protective layer further comprises a colorant;
the filler is taken from the group consisting of silicon dioxide, aluminum oxide, titanium dioxide, magnesium oxide, calcium oxide, and boron oxide; or
the one or more emissivity agents are taken from the group consisting of silicon hexaboride, boron carbide, silicon tetraboride, silicon carbide, molybdenum disilicide, tungsten disilicide, zirconium diboride, cupric chromite, and metallic oxides; or
combinations thereof.

3. The biomass combustion chamber of claim 1, wherein:
the stabilizer is taken from the group consisting of bentonite, kaolin, magnesium alumina silica clay, tabular alumina, and stabilized zirconium oxide.

4. The biomass combustion chamber of claim 1, wherein:
a thermal protective layer contains
a. from about 5% to about 35% of colloidal silica, colloidal alumina, or combinations thereof; from about 23% to about 79% of a filler taken from the group consisting of silicon dioxide, aluminum oxide, titanium dioxide, magnesium oxide, calcium oxide, and boron oxide; and from about 1% to about 20% of one or more emissivity agents taken from the group consisting of silicon hexaboride, boron carbide, silicon tetraboride, silicon carbide, molybdenum disilicide, tungsten disilicide, zirconium diboride, cupric chromite, and metallic oxides; or
b. from about 5% to about 35% of colloidal silica, colloidal alumina, or combinations thereof; from about 23% to about 79% of a filler taken from the group consisting of silicon dioxide, aluminum oxide, titanium dioxide, magnesium oxide, calcium oxide, and boron oxide; and from about 1% to about 20% of one or more emissivity agents taken from the group consisting of silicon hexaboride, boron carbide, silicon tetraboride, silicon carbide, molybdenum disilicide, tungsten disilicide, zirconium diboride, cupric chromite, and metallic oxides; and from about 1.5% to about 5.0% of a stabilizer taken from the group consisting of bentonite, kaolin, magnesium alumina silica clay, tabular alumina, and stabilized zirconium oxide.

5. The biomass combustion chamber of claim 1, wherein:
a thermal protective layer contains
a. from about 10% to about 30% colloidal silica, from about 50% to about 79% silicon dioxide powder, and from about 2% to about 20% of one or more emissivity agents taken from the group consisting of iron oxide, boron silicide, boron carbide, silicon tetraboride, silicon carbide molybdenum disilicide, tungsten disilicide, and zirconium diboride; or
b. from about 10% to about 30% colloidal silica, from about 50% to about 79% silicon dioxide powder, from about 2% to about 20% of one or more emissivity agents taken from the group consisting of iron oxide, boron silicide, boron carbide, silicon tetraboride, silicon carbide molybdenum disilicide, tungsten disilicide, and zirconium diboride, and from about 1.5% to about 5.0% of a stabilizer taken from the group consisting of bentonite, kaolin, magnesium alumina silica clay, tabular alumina, and stabilized zirconium oxide.

6. The biomass combustion chamber of claim 1, wherein:
at least part of at least a wall of the combustion chamber has a plurality of refractory bricks or sheets forming the internal surface of the combustion chamber.

7. The biomass combustion chamber of claim 6, wherein:
the thermal protective layer is disposed upon at least one exposed surface of the refractory bricks or panels.

8. The biomass combustion chamber of claim 1, wherein:
at least part of at least a refractory wall of the combustion chamber is composed of a composite refractory material.

9. A refractory wall component, comprising:
ceramic refractory materials; and
a thermal protective layer disposed on at least one surface of the refractory wall component;
wherein the thermal protective layer contains
a. from about 5% to about 35% of colloidal silica, colloidal alumina, or combinations thereof; from about 23% to about 79% of a filler, from about 1% to about 20% of one or more emissivity agents, or
b. from about 5% to about 35% of colloidal silica, colloidal alumina, or combinations thereof; from about 23% to about 79% of a filler, from about 1% to about 20% of one or more emissivity agents, and from about 1.5% to about 5.0% of a stabilizer.

10. The refractory wall component of claim 9, wherein:
the thermal protective layer further comprises up to about 0.25% of a surfactant;
the thermal protective layer further comprises a colorant;
the filler is taken from the group consisting of silicon dioxide, aluminum oxide, titanium dioxide, magnesium oxide, calcium oxide, and boron oxide;
the one or more emissivity agents taken from the group consisting of silicon hexaboride, boron carbide, silicon tetraboride, silicon carbide, molybdenum disilicide, tungsten disilicide, zirconium diboride, cupric chromite, and metallic oxides; or
the stabilizer is taken from the group consisting of bentonite, kaolin, magnesium alumina silica clay, tabular alumina, and stabilized zirconium oxide; or
combinations thereof.

11. The refractory wall component of claim 9, wherein:
a thermal protective layer contains
a. from about 5% to about 35% of colloidal silica, colloidal alumina, or combinations thereof; from about 23% to about 79% of a filler taken from the group consisting of silicon dioxide, aluminum oxide, titanium dioxide, magnesium oxide, calcium oxide, and boron oxide; and from about 2% to about 20% of one or more emissivity agents taken from the group consisting of silicon hexaboride, boron carbide, silicon tetraboride, silicon carbide, molybdenum disilicide, tungsten disilicide, zirconium diboride, cupric chromite, and metallic oxides; or
d. from about 5% to about 35% of colloidal silica, colloidal alumina, or combinations thereof; from about 23% to about 79% of a filler taken from the group consisting of silicon dioxide, aluminum oxide, titanium dioxide, magnesium oxide, calcium oxide, and boron oxide; and from about 2% to about 20% of one or more emissivity agents taken from the group consisting of silicon hexaboride, boron carbide, silicon tetraboride, silicon carbide, molybdenum disilicide, tungsten disilicide, zirconium diboride, cupric chromite, and metallic oxides; and from about 1.5% to about 5.0% of a stabilizer taken from the group consisting of bentonite, kaolin, magnesium alumina silica clay, tabular alumina, and stabilized zirconium oxide.

12. The refractory wall component of claim 9, wherein:
a thermal protective layer contains
a. from about 10% to about 30% colloidal silica, from about 50% to about 79% silicon dioxide powder, and from about 2% to about 20% of one or more emissivity agents taken from the group consisting of iron oxide, boron silicide, boron carbide, silicon tetraboride, silicon carbide molybdenum disilicide, tungsten disilicide, and zirconium diboride; or
b. from about 10% to about 30% colloidal silica, from about 50% to about 79% silicon dioxide powder, from about 2% to about 20% of one or more emissivity agents taken from the group consisting of iron oxide, boron silicide, boron carbide, silicon tetraboride, silicon carbide molybdenum disilicide, tungsten disilicide, and zirconium diboride, and from about 1.5% to about 5.0% of a stabilizer taken from the group consisting of bentonite, kaolin, magnesium alumina silica clay, tabular alumina, and stabilized zirconium oxide.

13. The refractory wall component of claim 9, wherein:
the refractory material is fashioned into a refractory brick or a refractory board.

14. The refractory wall component of claim 9, wherein:
the refractory material is composed of a castable refractory material having an exposed surface with the thermal protective layer disposed thereon.

15. A method of forming a thermal protective layer on a refractory surface in a biomass combustion chamber, comprising:
cleaning an exposed surface on a refractory component;
providing a mixed thermal protective high emissivity coating containing from about 15% to about 45% of colloidal silica, colloidal alumina, or combinations thereof; from about 23% to about 55% of a filler, from about 0.5% to about 10% of one or more emissivity agents, and from about 18% to 50% water; and
applying the thermal protective coating to the exposed surface using a spray gun to form a thermal protective layer from about 2 mils (5 microns) to about 10 mils (260 microns) thick.

16. The method of claim 15, wherein:
the thermal protective layer further comprises from about 0.5% to about 2.5% of a stabilizer;
the thermal protective layer further comprises up to about 0.25% of a surfactant;
the thermal protective layer further comprises a colorant;
the filler is taken from the group consisting of silicon dioxide, aluminum oxide, titanium dioxide, magnesium oxide, calcium oxide, and boron oxide; or
the one or more emissivity agents are taken from the group consisting of silicon hexaboride, boron carbide, silicon tetraboride, silicon carbide, molybdenum disilicide, tungsten disilicide, zirconium diboride, cupric chromite, and metallic oxides; or
combinations thereof.

17. The method of claim 16, wherein:
the stabilizer is taken from the group consisting of bentonite, kaolin, magnesium alumina silica clay, tabular alumina, and stabilized zirconium oxide.

18. The method of claim 15, wherein:
the spray gun is taken from the group consisting of an high volume low pressure spray gun or an airless spray gun.

19. The method of claim 15, further comprising:
agitating the solution of thermal protective coating.

20. The method of claim 15, further comprising:
rotating the direction of spray to facilitate an even thickness.

21. The method of claim 15, further comprising:
allowing the thermal protective layer to air dry from about two to about four hours.

22. The method of claim 15, wherein:
the refractory component is a refractory brick, a refractory board, or a refractory castable, or combinations thereof.
